(19) United States
(12) Patent Application Publication
(10) Pub. No.: US 2005/0039809 A1
(43) Pub. Date: Feb. 24, 2005

(54) Flow sensor with integrated delta P flow restrictor

(76) Inventor: Jamie W. Speldrich, Freeport, IL (US)

Correspondence Address: Kris T. Fredrick;Patent Services, Honeywell International Inc., 101 Columbia Road, Morristown, NJ, 07962, US

(21) Appl. No.: 10/646,492

(22) Filed: Aug. 21, 2003

(51) Int. Cl. F15D 1/00

(52) U.S. Cl. 138/39; 138/44

(57) ABSTRACT

A high mass flow sensor device having a flow restrictor formed by a body having a generally cylindrical shape with an upstream end and a downstream end separated by a center portion having pressure taps proximate the junction of the ends with the center portion. Flow passes from upstream to downstream. The upstream end has a decreasing tapering inner surface for contact with the flow and the downstream end having an increasing tapering inner surface for contact with the flow. A center portion has radial and axial restrictor elements positioned forming axial openings in the path of flow through the center portion. The restrictor elements having tapered leading edges. One opening is formed by a central tube having a predetermined diameter and the remaining openings are radially extending members supporting the central tube, each of the radially extending members having substantially the same cross-sectional area as the central tube.

### FIELD OF THE INVENTION

The present invention relates to a high mass flow sensor having a restrictor and an airflow sensor in parallel with the restrictor. More particularly, the invention relates to an improved design of the restrictor itself.

### BACKGROUND OF THE INVENTION

Flow rate control mechanisms are used in a variety of flow systems as a means for controlling the amount of fluid, gaseous or liquid, traveling through the system. In large-scale processing systems, for example, flow control may be used to affect chemical reactions by ensuring that proper feed stocks, such as catalysts and reacting agents, enter a processing unit at a desired rate of flow. Additionally, flow control mechanisms may be used to regulate flow rates in systems such as ventilators and respirators where, for example, it may be desirable to maintain a sufficient flow of breathable air or provide sufficient anesthetizing gas to a patient in preparation for surgery.

Typically, flow rate control occurs through the use of circuitry responsive to measurements obtained from carefully placed flow sensors. One such flow sensor is a thermal anemometer with a conductive wire extending radically across a flow channel and known as a hot-wire anemometer. These anemometers are connected to constant curve sources which cause the temperature of the wire to increase proportionally with an increase in current. In operation, as a fluid flows through the flow channel and, thus, past the anemometer, the wire cools due to convection effects. This cooling affects the resistance of the wire, which is measured and used to derive the flow rate of the fluid. Another form of thermal anemometer flow sensor is a microstructure sensor, either a microbridge, micro-membrane, or micro-brick, disposed at a wall of a flow channel. In this form, the sensors ostensibly measures the flow rate by sampling the fluid along the wall of the flow channel. In either application, the thermal anemometer flow sensor is disposed in the flow channel for measuring rate of flow.

There are numerous drawbacks to these and other known flow sensors. One drawback is that the proportional relationship upon which these sensors operate, i.e., that the conductive wire or element will cool linearly with increases in the flow rate of the fluid due to forced convection, does not hold at high flow velocities where the sensors become saturated. This saturation can occur over a range of 10 m/s to above 300 m/s depending on the microstructure sensor, for example. As a result, in high flow regions, measured resistance of an anemometer, or other sensor, no longer correlates to an accurate value of the flow rate. Furthermore, because these sensors reside in the main flow channel, they are susceptible to physical damage and contamination.

An indirect flow measuring technique that measures flow rate from a sensor positioned outside of the flow channel and improves upon some of the drawbacks of direct contact measurement has been designed. In one form, AP pressure sensors measure a pressure drop across a flow restrictor, which acts as a diameter reducing element in the flow channel thereby creating a difference in pressure between an entrance end and an exit end of the flow restrictor. These flow restrictors have been in either honeycomb-patterned or porous metal plate restrictors. The pressure sensors are disposed in dead-end channels to measure the pressure drop due to the flow restrictor, with this pressure drop being proportional to the flow rate of the fluid. In other forms, the indirect flow mechanism can use a translucent tube disposed near the flow channel with a free-moving mall or indicator that rises and falls with varying flow rate conditions in the flow channel, or a rotameter, such as a small turbine or fan, that operates as would a windmill measuring wind rate.

Though they offer some improvement over sensors disposed directly in the flow channel, all of these indirect flow sensors are hampered by calibration problems. An indirect flow sensor may be calibrated to work generally with certain types of restrictors, e.g., honeycomb restrictors, but imprecise restrictor geometry results in variations in pressure and, therefore, variations in measured flow rate. Furthermore, the sensors are not calibrated for use with other types of restrictors.

Typical designs comprise a flow sensor, such as a high mass flow sensor having a restrictor and an airflow sensor in parallel with the restrictor.

It would be of advantage in the art if an improved design would have more accurate readings.

It would be another advance in the art if the sensor would produce accurate results over a wide range of operating conditions.

Other advantages will appear hereinafter.

### SUMMARY OF THE INVENTION

It has now been discovered that the above and other objects of the present invention may be accomplished in the following manner. Specifically, the present invention provides a restrictor for use with airflow sensors where the restrictor and the airflow sensor are in parallel with each other.

The restrictor of this invention includes a body portion having a generally cylindrical shape with an upstream end and a downstream end separated by a center portion. Pressure taps are located proximate the junction of the ends with the center portion, whereby flow passes from upstream to downstream in parallel through the sensor, which is conventional, and the restrictor of the present invention. The upstream end has a decreasing tapering inner surface for contact with the flow of fluid through the restrictor. Similarly, the downstream end has an increasing tapering inner surface for contact with the flow as it leaves the restrictor. The center portion has radial and axial restrictor elements positioned in the path of flow through the center portion. The restrictor elements have tapered leading edges to minimize turbulence.

### BRIEF DESCRIPTION OF THE DRAWINGS

For a more complete understanding of the invention, reference is hereby made to the drawings, in which:

FIG. 1 is a perspective view of a flow sensor in which a flow restrictor is used to control the flow of fluids through such a sensor;

FIG. 2 is a side elevational view of a prior art flow sensor device;

FIG. 3 is a cross-sectional view taken along the line 3-3 of FIG. 2;

FIG. 4 is a side elevational view of a flow sensor device incorporating the flow restrictor of the present invention; and

FIG. 5 is a cross-sectional view taken along the line 5-5 of FIG. 4.

### DETAILED DESCRIPTION OF THE PREFERRED EMBODIMENT

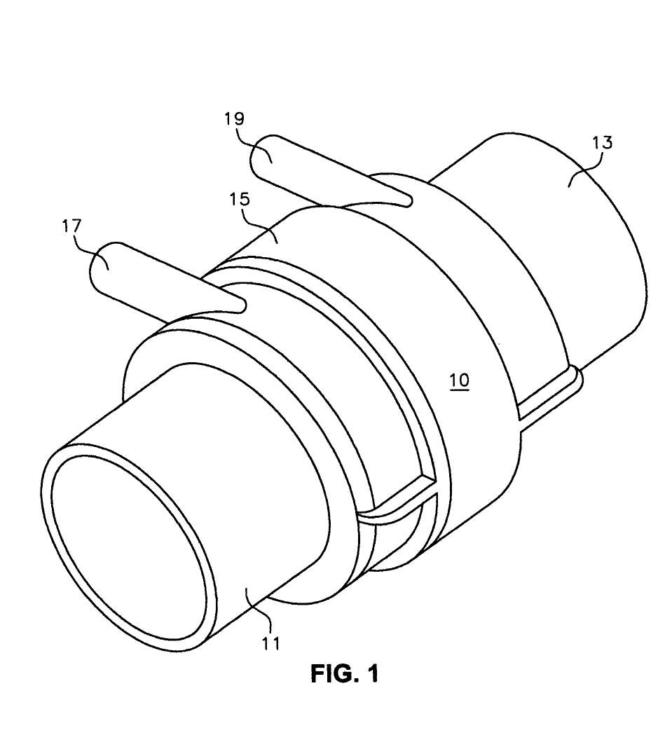

The present invention provides for substantial improvements in the operation of a fluid flow sensor, 10 generally, such as that shown in FIG. 1. The sensor is fitted in a flow path such that fluid, either liquid or gas as the system dictates, enters the inlet 11 and exits outlet 13. The body 15 of the sensor includes pressure tap inlet 17 and outlet 19 where fluid is removed and measured using conventional equipment, not shown.

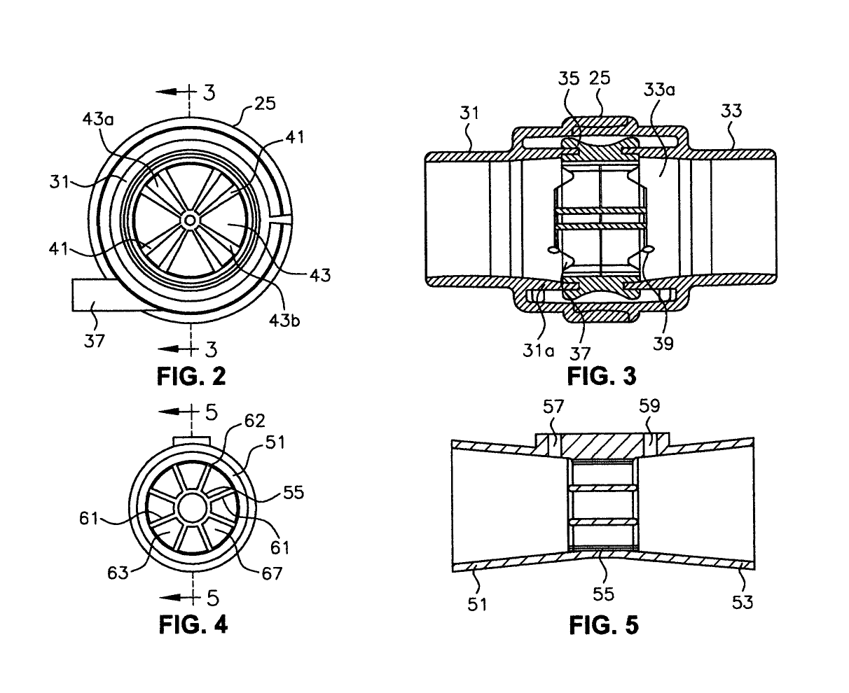

Body 15 contains a flow restrictor that is provided to handle the fluid flow as it passes through the body and fluid is directed to the airflow or pressure sensor via inlet 17 and outlet 19. FIGS. 2 and 3 represents a prior art flow sensor and flow restrictor, where body 25 includes a cylindrical inlet portion 31, a cylindrical outlet portion 33 and a flow restrictor 35 in the middle. Pressure taps 37 and 39 feed the inlet and outlet 17 and 19 respectively of FIG. 1. A plurality of vanes 41 define a plurality of channels 43 though which fluid flows.

This prior art device has, as can be seen, non-uniform channel sizes 43a and 43b, for example. Because inlet portion 31 is cylindrical and actually expands at 31a where it joins flow restrictor 35, and because outlet portion 33 is also cylindrical and actual contracts at 33a where it joins flow restrictor 35, unstable flow develops and readings from the device are not reproducible or uniform. Vanes 41 also present a blunt surface to the fluid and add to unstable flow.

FIGS. 4 and 5 illustrate the present invention, in which the inlet 51 is tapered, as is the outlet 53, so that flow is more precisely controlled. The flow restrictor 55 mates with inlet 51 and causes the low flow velocity near the walls of inlet 51 and restrictor 55 to increase. Thus, rather than a parabolic shape flow pattern with high velocity at the center of the tube, the flow will be more uniform across the diameter of the tube. A uniform flow pattern will encourage more laminar flow with less noise in the signal. By blending the restrictor 55 and outlet 53 an increasing taper prevents any back pressure on the restrictor 55. Vanes 61 are uniform in size and define approximately equal channels 63, to cause a more uniform velocity distribution through restrictor 55 and reduce high Reynolds number in these larger openings and, thus, avoid inflicting noise on the sensor signal.

By blending the upstream geometry into the restrictor and removing the large upstream and downstream diameters on either side of the central portion, there is less separation and instability near the wall, again reducing noise. Finally, the tapered edges 62 on the leading edges of the restrictor vanes 61 reduces separation when the flow contacts the restrictor 55.

While particular embodiments of the present invention have been illustrated and described, it is not intended to limit the invention, except as defined by the following claims.

1. A high mass flow sensor device having a flow restrictor, said flow restrictor comprising:
a body having a generally cylindrical shape with an upstream end and a downstream end separated by a center portion having pressure taps proximate the junction of said ends with said center portion, whereby flow passes from upstream to downstream;
said upstream end having a decreasing tapering inner surface for contact with said flow;
said downstream end having an increasing tapering inner surface for contact with said flow; and
said center portion having radial and axial restrictor elements positioned in the path of flow through said center portion, said restrictor elements having tapered leading edges.

2. The device of claim 1, wherein said decreasing tapering inner surface of said upstream end decreases sufficiently to cause low velocity flow proximate the inner surface to increase.

3. The device of claim 2, wherein said decreasing tapering inner surface of said upstream end decreases sufficiently to prevent formation of a parabolic shape flow pattern and maintain a uniform flow through said upstream end.

5. The device of claim 3, wherein said downstream end increasing taper reduces noise caused by separation and instability of the flow.

5. The device of claim 1, wherein said restrictor elements form a plurality of openings for flow through said central portion, said plurality of openings have substantially similar size areas and approximate diameters.

6. The device of claim 5, wherein one of said plurality of openings is formed by a central tube portion having a predetermined diameter and the remaining of said plurality of openings are formed by radially extending members supporting said central tube portion, each of said radially extending members forming portions having substantially the same cross-sectional area as said central tube portion.

7. The device of claim 1, wherein said tapered leading edges on said restrictor elements are tapered to an edge for reducing separation of the flow as the flow contacts said restrictor elements.

8. A high mass flow sensor device having a flow restrictor, said flow restrictor comprising:
body means for forming said flow restrictor, said body means having a generally cylindrical shape with an upstream end and a downstream end separated by center portion means having pressure tap means for measuring pressure in said flow, said pressure tap means being proximate the junction of said ends with said center portion, whereby flow passes from upstream to downstream;
said upstream end having a decreasing tapering inner surface for contact with said flow;
said downstream end having an increasing tapering inner surface for contact with said flow; and
said center portion means having radial and axial restrictor element means for engagement with said flow and positioned in the path of flow through said center portion means, said restrictor element means having tapered leading edges.

9. The device of claim 8, wherein said decreasing tapering inner surface of said upstream end decreases sufficiently to cause low velocity flow proximate the inner surface to increase.

10. The device of claim 9, wherein said decreasing tapering inner surface of said upstream end decreases sufficiently to prevent formation of a parabolic shape flow pattern and maintain a uniform flow through said upstream end.

11. The device of claim 10, wherein said downstream end increasing taper reduces noise caused by separation and instability of the flow.

12. The device of claim 8, wherein said restrictor element means forms a plurality of openings for flow through said central portion means, said plurality of openings have substantially similar size areas and approximate diameters.

13. The device of claim 12, wherein one of said plurality of openings is formed by a central tube portion having a predetermined diameter and the remaining of said plurality of openings are formed by radially extending members supporting said central tube portion, each of said radially extending members forming portions having substantially the same cross-sectional area as said central tube portion.

14. The device of claim 8, wherein said tapered leading edges on said restrictor elements are tapered to an edge for reducing separation of the flow as the flow contacts said restrictor elements.

15. A method of restricting flow in a high mass flow sensor device having a flow restrictor, comprising the steps of:
placing a body having a generally cylindrical shape with an upstream end and a downstream end separated by a center portion having pressure taps proximate the junction of said ends with said center portion in a mass flow sensor device, whereby flow passes from upstream to downstream through said body;
said upstream end having a decreasing tapering inner surface for contact with said flow;
said downstream end having an increasing tapering inner surface for contact with said flow; and
said center portion having radial and axial restrictor elements positioned in the path of flow through said center portion, said restrictor elements having tapered leading edges.

16. The method of claim 15, wherein said decreasing tapering inner surface of said upstream end decreases sufficiently to cause low velocity flow proximate the inner surface to increase.

17. The method of claim 15, wherein said decreasing tapering inner surface of said upstream end decreases sufficiently to prevent formation of a parabolic shape flow pattern and maintain a uniform flow through said upstream end and reduces noise caused by separation and instability of the flow.

18. The method of claim 15, wherein said restrictor elements form a plurality of openings for flow through said central portion, said plurality of openings have substantially similar size areas and approximate diameters.

19. The method of claim 18, wherein one of said plurality of openings is formed by a central tube portion having a predetermined diameter and the remaining of said plurality of openings are formed by radially extending members supporting said central tube portion, each of said radially extending members forming portions having substantially the same cross-sectional area as said central tube portion.

20. The method of claim 15, wherein said tapered leading edges on said restrictor elements are tapered to an edge for reducing separation of the flow as the flow contacts said restrictor elements.
